(19) United States
(12) Patent Application Publication
(10) Pub. No.: US 2007/0162954 A1
(43) Pub. Date: Jul. 12, 2007

(54) Network security system based on physical location

(76) Inventor: Peter L. Pela, Phoenix, AZ (US)

Correspondence Address: STROOCK & STROOCK & LAVAN LLP, 180 MAIDEN LANE, NEW YORK, NY, 10038, US

(21) Appl. No.: 10/551,568

(22) PCT Filed: Apr. 5, 2004
(86) PCT No.: PCT/US04/10507

§ 371 Date: Sep. 22, 2006

Related U.S. Application Data
(60) Provisional application No. 60/461,002, filed on Apr. 7, 2003.

(51) Int. Cl. H04L 9/32; G06K 9/00

(52) U.S. Cl. 726/2

(57) ABSTRACT

A network security system and method for monitoring, tracking, and authorizing the physical location of a network login. More specifically, the present invention relates to a system that maintains records (200) of authorized network users and monitors, tracks, and authorizes the physical location from which those users are authorized to access a computer network.

### CROSS-REFERENCE TO RELATED APPLICATIONS

The present application claims the benefit of U.S. Provisional Application No. 60/461,002, filed Apr. 7, 2003, which is incorporated herein by reference.

### FIELD OF THE INVENTION

The present invention relates to a network security system and method for monitoring, tracking, and authorizing the physical location of a network login. More specifically, the present invention relates to a system that maintains records of authorized network users and monitors, tracks, and authorizes the physical location from which those users are authorized to access a computer network.

### BACKGROUND OF THE INVENTION

In many businesses employees are assigned their own computer network access number exchange so that the employee can interface with the company's computer network. The access number provides security to the company's network and prevents those unauthorized to use the network system from accessing the network. However, there exist circumstances in which a user who does not have authorized access to a company's network can maliciously break into network systems in order to gain unlawful access to valuable information or to ruin network programs. This unfortunate problem is not isolated to users outside the network; there are also instances in which employees, having authorization or stolen authorization, access the network for the purpose of ruining network programs or obtaining proprietary information.

The problems of maintaining security for company network systems are well known in the art. One type of system that deals with network security problems is a firewall. A firewall is a set of related programs that protects the resources of a private network, or intranet, from users outside the network and also controls what outside resources users of the network can access. A firewall is located at a network's gateway server, the network entrance point, and is often installed in a specially designated computer that is separate from the network. Essentially, a firewall examines each network packet, or unit of data routed between an origin and a destination on the Internet or other network, to determine if it should be forwarded to its destination. Firewall screening methods include, for example, screening requests to ensure the requests come from acceptable domain name and Internet Protocol addresses. Mobile network users are allowed remote access to the network by the use of secure logon procedures and authentication.

In such systems, the focus of network security is on protecting the network from users of other networks. That is, firewalls protect private networks from unauthorized external users of a company's network, such as the proverbial computer hacker. However, there is no security system or device that protects a private network from an inside network user, such as a rogue employee. Because employees typically have authorization, that is, an authorized Username and Password, to access a company's network, the most potentially damaging security threat is posed not from an external user over the Internet but rather from within the company itself over the local area network, that is, “insider hacking.” The prior art systems fail to prevent this type of security threat.

Thus, while the systems described above have been adequate for the applications for which they are designed, the need exists for an additional network security system which can prevent unlawful or unauthorized activities by an otherwise authorized network user.

### SUMMARY OF THE INVENTION

The present invention relates to a network security system and method for monitoring, tracking, and authorizing the physical location of a network login. More specifically, the present invention relates to a system that maintains records of authorized network users and monitors, tracks, and authorizes the physical location from which those users are authorized to access a computer network.

The system of the present invention generally comprises a software component and a hardware component The software component monitors the access of network users and constructs a database which can include records of network login attempts and information such as, for example, the login ID, or Username and Password; the workstation name, including the IP/MAC address, and the physical location and time of the login.

The hardware component of the present invention includes a system for determining the physical location from which a user attempts to connect to the network. The hardware component comprises a microprocessor that monitors the connection of data ports and generates a database which contains physical location information associated with the network computers and related equipment.

When a user attempts to connect or connects to the network, the system of the present invention monitors the network security server, which grants or denies initial access to the network, and records login information. Specifically, the microprocessor of the hardware component, which continuously monitors the connection of data ports, communicates the data port connection information to a database. The software component looks up the physical location information on the database generated by the hardware component to determine, among other things, whether the user is authorized to login from the particular physical location of the login. That is, the software component monitors the access granted by the security server to determine whether a particular user, which has been granted initial access, is authorized to login from a particular location. If the user is not authorized to login from a particular login location, the software component can take preventive action such as instructing the switch or patch panel of the hardware component to shut down the user's data port. The software component also maintains records of network login attempts in an event log.

Other objects and features of the present invention will become apparent from the following detailed description, considered in conjunction with the accompanying drawing figures. It is to be understood, however, that the drawings are designed solely for the purpose of illustration and not as a definition of the limits of the invention, for which reference shall be made to the appended claims.

### BRIEF DESCRIPTION OF THE DRAWINGS

In the drawing figures, which are not drawn to scale, and which are merely illustrative and wherein like reference characters denote similar elements throughout the several views:

FIG. 1 is a schematic illustrating the overall system of the present invention.

FIG. 2 is a table illustrating the database of Data Port Connection Information according to one embodiment of the present invention.

### DETAILED DESCRIPTION OF THE PRESENTLY PREFERRED EMBODIMENTS

The present invention relates to a network security system and method for monitoring, tracking, and authorizing the physical location of a network login. More specifically, the present invention relates to a system that maintains records of logins of network users and monitors, tracks, and authorizes the physical location from which those users are allowed to access a computer network.

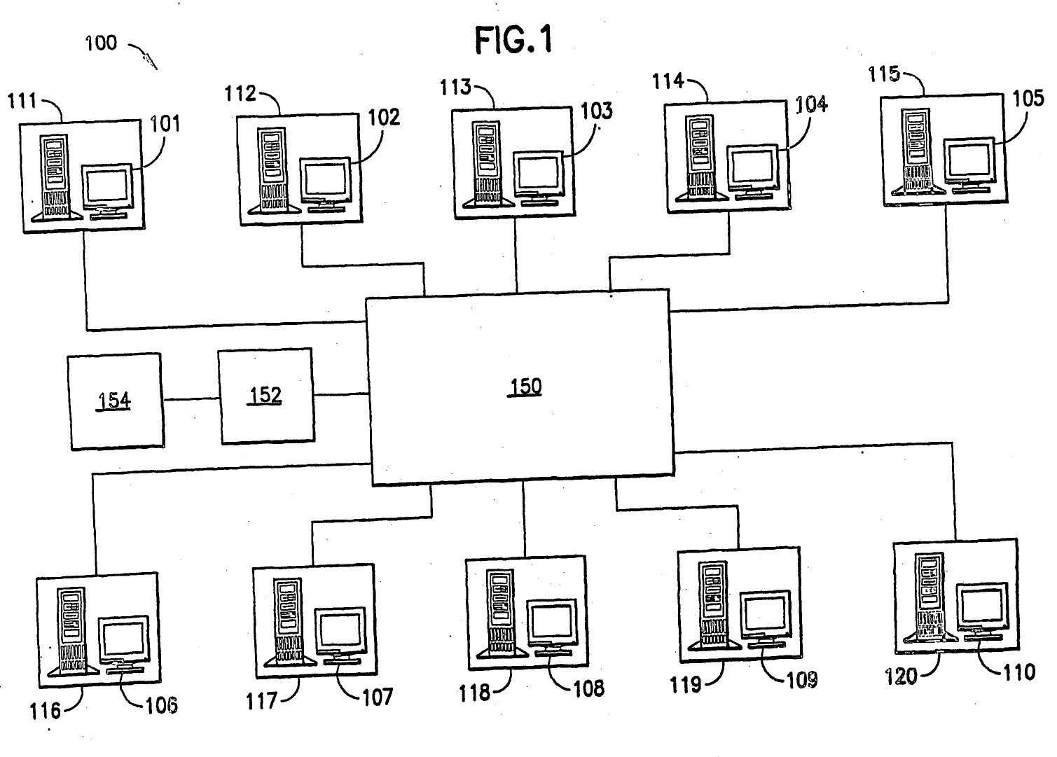

FIG. 1 depicts a schematic of a network security system according to one embodiment of the present invention. In general, the system allows a network manager, such as a company, to control network logins and thereby prevent or prohibit breaches of network security and/or track or monitor for investigative or administrative purposes the physical location from which users access the network.

As seen in FIG. 1, the network security system of the present invention includes workstations, generally indicated as 101 through 110, that consist of a computer, which can be a desktop or laptop, and other related equipment. Each workstation, 101 through 110, is associated with a specific physical location, generally indicated as 111 through 120, such as, for example, an office, floor of a building, portion of a floor of a building or department, or any other type of desired physical boundary. Workstations, 101 through 110, are coupled to each other via a local area-network (LAN), generally indicated as 150. More specifically, workstations, 101 through 110, a security server, generally indicated as 152, an administration terminal, generally indicated as 154, and the hardware component of the present invention are all in communication via LAN 150.

Network users, or employees, can be associated with one particular workstation, 101 through 110, and one physical location, 111 through 120, or multiple workstations and/or physical locations. As described in more detail below, a user at a workstation in a particular physical location enters a Username and Password. Security server 152, which can include one or more security servers, can be coupled to LAN 150 or directly to each workstation and grants or denies initial network access based upon the Username and Password entered by a user.

The hardware component of the present invention, which is connected to LAN 150, monitors the connection pattern of data ports on a switch or patch panel. The hardware component comprises a system for determining the connection of data ports, which includes a switch or patch panel that is electrically connected to a microprocessor, which continually records and updates data port connection information. One such system is described in issued U.S. Pat. No. 6,574,586. Other such hardware systems are known in the art and contemplated herein. That is, the present invention is not limited to any particular hardware component and will work equally well with any type of hardware component that can determine the physical location of an attempted login. The present invention also contemplates an embodiment with no hardware system wherein the data port connection information is manually entered into the database of a microprocessor.

The software component of the present invention monitors the activity of security server 152, determines whether the user is authorized to login to the network at the specific login location, takes the necessary action upon determining a user is unauthorized, and maintains records of login attempts. Security server 152 grants or denies initial access to the network based upon a comparison of the user's entered Username and Password and the Username and Password stored on security server 152 or on another network PC/Server. The software component then looks up the data port connection information generated by the hardware component to determine if the user has been granted authorization to access the network from that particular physical location. If the user is not authorized to access the network from that particular physical location, the software component can take various preventive actions, for example, instructing the switch or patch panel of the hardware component to shut down the user's data port or issuing an alert to the administrative terminal 154.

The software component also maintains records of login attempts, successful or unsuccessful. Specifically, the software component generates a database, or event log, which contains login identification information, such as, for example, Usernames and Passwords, workstation identification information, including IP/MAC address, date and time of each login attempt, date and time of each authorized login, login type description, network security agent, domain address, network resources accessed, server identification, whether the attempted login was successful or unsuccessful, number of login attempts, device identification (e.g., host name), IP address, MAC address, jack or outlet identification, jack or outlet location, port identification, and any other circuit trace information.

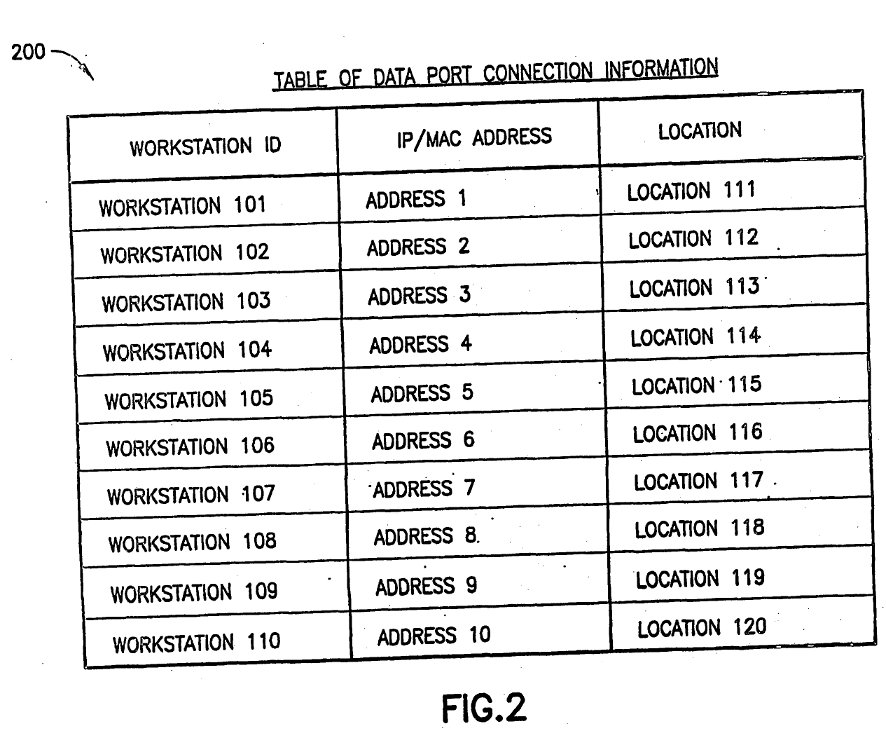

The database of the hardware component will now be described in greater detail with reference to FIG. 2, and continuing reference to FIG. 1. The database of the hardware component includes a table of information, which is described below. As appreciated by one skilled in the art, the following arrangement of information in a table is exemplary and other arrangements are within the scope of the present invention.

The database of the hardware component includes a Data Port Connection Information Table 200, as shown in FIG. 2. In general, Data Port Connection Information Table 200 includes records for each workstation, as identified by a Workstation ID. Each such record includes the IP/MAC address and the physical location (such as an office). For example, Workstation 101 is associated with Address 1 and Location 111. Workstation 102 is associated with Address 2 and Location 112. Workstation 103 is associated with Address 3 and Location 113. Workstation 104 is associated with Address 4 and Location 114. The remaining workstations are similarly numbered as identified in Table 200.

Having described the components of the present embodiment, the operation thereof will now be described. As an initial matter, the network manager provides user-identifying information to a security server database. More specifically, the network manager provides to security server 152 or another network PC/Server the Username and Password of each network user. In one embodiment of the present invention, the network manager manually enters the user-identifying information into the security server database 152 via administration terminal 154.

Once a user enters a Username and Password into a network computer, the entered information is communicated to security server 152 via LAN 150. Security server 152 receives the information and compares the information stored in a security server database. Specifically, security server 152 grants or denies initial network access based upon the entered Username and Password.

Concurrently, the hardware component of the present invention monitors the connection of data ports. Specifically, a system such as that disclosed in issued U.S. Pat. No. 6,574,586 determines the connectivity of each workstation and related equipment and their physical location. The microprocessor within the hardware component continuously receives, records, and updates a database of the data port connection information.

When a user logs onto the network, the software component retrieves information identifying the workstation, 101 through 110 of FIG. 1, and location, 111 through 120 of FIG. 1, from which the user is attempting the logon. The software component records the login information and takes prevent action, as described above, if necessary.

By way of example, with reference to FIGS. 1 and 2, as described above, a user is associated with Workstation 101 and Location 111. The user enters a Username and Password and is either granted or denied initial network access by security server 152. According to the present invention, if the user accesses the network from Workstation 103 in Location 113, the software component retrieves the data port connection information from the hardware component database, represented by Table 200, to determine if the user is authorized to login to the network at that location. While the user may have been granted initial access to the network by entering the correct Username and Password, Workstation 103 and Location 113 are not associated with the user. Thus, the user's access can be disconnected or an alert message can be issued to administrative terminal 154. Additionally, the software component records information pertaining to this failed login event.

In another example, Workstations 101 through 110 can be laptop computers, or otherwise portable workstations, and therefore can be used at various locations. As described above, a user is associated with Workstation 101 and Location 111. According to the present invention, if the user accesses the network at Workstation 101 in Location 113, the software component retrieves the data port connection information from the hardware component database, represented by Table 200, to determine if the user is authorized to login to the network at that location. While the user may have been granted initial access to the network by entering the correct Username and Password, and although Workstation 101 is associated with the user, Location 113 is not associated with the user. Thus, the user's access can be disconnected or an alert message can be issued to administrative terminal 154. Additionally, the software component records information pertaining to this failed login event.

In an alternate embodiment, the software component of the present invention can also monitor Usernames and Passwords in order to grant or deny initial access to the network.

While there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall there between.

I claim:

1. A method for providing security to a computer network by monitoring the physical location of a network login or login attempts said method comprising:
associating a workstation to a physical location;
associating a network user to said workstation;
monitoring a computer network to determine a network login or attempted login of said user;
determining a physical location of said login or attempted login;
determining whether said user is authorized to access said network from said physical location of said login or attempted login.

2. The method of claim 1, further comprising determining whether preventive action is necessary and, if so, automatically initiating preventive action.

3. The method of claim 2, wherein said preventive action comprises generating an alert.

4. The method of claim 2, wherein said preventive action comprises disconnecting said workstation from said network.

5. The method of claim 2, wherein said preventive action comprises generating a notification message that said user is accessing said computer network from an unauthorized location.

6. The method of claim 1, further comprising storing information regarding said physical location of said login or attempted login.

7. The method of claim 1, further comprising storing information regarding said workstation associated with said login or attempted login.

8. The method of claim 7, wherein said workstation information includes one or more of the following types of information: an IP/MAC address of said workstation, a date and time of each login attempt, a date and time of each successful login, login type description, network security agent, domain address, information regarding which network resources were accessed, server identification, the number of login attempts, host name data, jack or outlet information, port identification, or any other circuit trace information.

9. The method of claim 1, further comprising generating an event log.

10. The method of claim 7, wherein said event log comprises information regarding said physical location of said login or attempted login and information regarding said user.

11. The method of claim 1, further comprising associating said user with a workstation.

12. A method for providing security to a computer network by monitoring a network login or login attempt from a particular workstation, said method comprising:
associating a workstation to a physical location;
associating a network user to said workstation;
monitoring a computer network to determine a network login or attempted login of said user;
determining which workstation said login or attempted login is generated from;
determining whether said user is authorized to access said network from said workstation of said login or attempted login.

13. A network security system for a plurality workstations coupled via a local area network, said network said security system comprising:
electronic storage for associating said workstations to a user and a physical location; and
one or more processors for receiving login information from said workstations and accessing said electronic storage to determine whether said user or said workstation is authorized to login to said network from said physical location.

14. The system of claim 13, wherein said one or more processors generates an alert based said determination.

15. The system of claim 14, wherein said alert comprises an email notification.

16. The system of claim 14, wherein said alert comprises a pager notification.

17. The system of claim 14, wherein said alert comprises a termination signal.

18. The system of claim 14, wherein said one or more processors generates an event log.

19. The system of claim 18, wherein said event log comprises a time of said access.

20. The system of claim 18, wherein said event log comprises said physical location.

21. Computer readable medium having computer readable code for causing one or more processors to associating a workstation to a physical location;
associating a network user to said workstation;
monitoring a computer network to determine a network login or attempted login of said user;
determining a physical location of said login or attempted login;
determining whether said user is authorized to access said network from said physical location of said login or attempted login.

22. A network security system for a plurality workstations coupled via a local area network each workstation being associated with a specific user and coupled to one of a plurality of data ports of a patch panel, said patch panel being coupled to a computer network, said security system comprising:
a workstation associated with a physical location and a user;
a monitoring device for determining a network login or attempted login of said user,
a device for determining a physical location of said login or attempted login;
wherein said system determines whether said user is authorized to access said network from said physical location of said login or attempted login.
